(19) United States
(12) Patent Application Publication
(10) Pub. No.: US 2026/0362264 A1
(43) Pub. Date: Nov. 12, 2026

(54) METHOD AND APPARATUS FOR FAILURE HANDLING, PATH ADDITION AND PATH SWITCH IN A MULTIPATH SCENARIO

(71) Applicant: LENOVO (BEIJING) LIMITED, Beijing (CN)

(72) Inventors: Lianhai Wu, Beijing (CN); Ran Yue, Beijing (CN); Jing Han, Beijing (CN); Jie Hu, Beijing (CN)

(21) Appl. No.: 19/470,320

(22) PCT Filed: Sep. 27, 2023
(86) PCT No.: PCT/CN2023/122289

§ 371 Date: Sep. 29, 2025

(51) Int. Cl. H04W 36/00

(52) U.S. Cl. CPC H04W 36/033; H04W 36/0079

(57) ABSTRACT

Embodiments of the present disclosure relate to method and apparatus for failure handling, path addition and path switch in a multipath scenario. According to some embodiments of the disclosure, a UE may: connect to a BS via multiple paths comprising an indirect path through a relay node and a direct path; and receive a notification message or a PC5-S release message from the relay node, wherein the notification message or PC5-S release message is transmitted by the relay node due to a Uu link failure, a handover, a cell reselection, a connection establishment failure of the relay node. In addition, the UE may receive the notification message or the PC5-S release message from the relay node when the UE performs an indirect path addition or an indirect path switching.

### TECHNICAL FIELD

Embodiments of the present disclosure generally relate to wireless communication technology, and more particularly to failure handling, path addition and path switch in a multipath scenario.

### BACKGROUND

A wireless communication system may include one or multiple network communication devices, such as base stations, which may support wireless communication for one or multiple user communication devices, which may be otherwise known as user equipment (UE), or other suitable terminology. The wireless communication system may support wireless communication with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communication system may support wireless communication across various radio access technologies including third generation (3G) radio access technology, fourth generation (4G) radio access technology, fifth generation (5G) (which is also known as new radio (NR)) radio access technology, among other suitable radio access technologies beyond 5G (e.g., sixth generation (6G)).

In a wireless communication system, a user equipment (UE) may communicate with another UE via a data path supported by an operator's network, e.g., a cellular or a Wi-Fi network infrastructure. The data path supported by the operator's network may include a base station (BS) and multiple gateways. A wireless communication system may support multipath. For example, a UE may access a BS via a direct path and an indirect path through a relay node.

There is a need for handling failure handling, path addition and path switch in a multipath scenario.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

Some embodiments of the present disclosure provide a UE. The UE may include at least one memory; and at least one processor coupled with the at least one memory and configured to cause the UE to: connect to a BS via multiple paths comprising an indirect path through a relay node and a direct path; and receive a notification message or a PC5-S release message from the relay node, wherein the notification message or PC5-S release message is transmitted by the relay node due to a Uu link failure, a handover, a cell reselection, a connection establishment failure of the relay node.

In some embodiments of the present disclosure, the at least one processor is further configured to cause the UE to indicate, from a PC5-S layer of the UE to an access stratum (AS) layer of the UE, a release of a PC5 unicast link between the UE and the relay node in response to receiving the PC5-S release message.

In some embodiments of the present disclosure, the at least one processor is further configured to cause the UE to report failure information associated with the indirect path via the direct path in response to the direct path being not suspended. In some embodiments of the present disclosure, the at least one processor is further configured to cause the UE to perform a reestablishment procedure in response to the direct path being suspended.

In some embodiments of the present disclosure, the failure information may indicate a reception of the notification message or the PC5-S release message.

Some embodiments of the present disclosure provide a UE. The UE may include at least one memory; and at least one processor coupled with the at least one memory and configured to cause the UE to: connect to a BS via multiple paths comprising a first indirect path and a direct path; receive, from the BS, a reconfiguration message instructing the UE to switch from the first indirect path to a second indirect path, wherein the reconfiguration message may indicate a target relay node; and in response to receiving the reconfiguration message, start a timer for indirect path switch and perform an indirect path switch procedure towards the target relay node.

In some embodiments of the present disclosure, the at least one processor is further configured to cause the UE to: during the indirect path switch procedure, receive a notification message or a PC5-S release message from the target relay node or detect a sidelink radio link failure (RLF) between the UE and the target relay node.

In some embodiments of the present disclosure, the at least one processor is further configured to cause the UE to: stop the timer for indirect path switch or determine that the timer for indirect path switch is expired in response to receiving the notification message or the PC5-S release message or detecting the sidelink RLF.

In some embodiments of the present disclosure, the at least one processor is further configured to cause the UE to transmit, to the BS, failure information associated with indirect path switch via the direct path in response to receiving the notification message or the PC5-S release message or detecting the sidelink RLF.

In some embodiments of the present disclosure, the at least one processor is further configured to cause the UE to: transmit a sidelink reconfiguration message to the target relay node; receive a sidelink reconfiguration failure message from the target relay node in response to transmitting the sidelink reconfiguration message; and stop the timer for indirect path switch in response to receiving the sidelink reconfiguration failure message.

In some embodiments of the present disclosure, the at least one processor is further configured to cause the UE to: start a timer for sidelink reconfiguration in response to performing the indirect path switch procedure; and stop the timer for indirect path switch in response to the expiry of the timer for sidelink reconfiguration.

In some embodiments of the present disclosure, the at least one processor is further configured to cause the UE to transmit, to the BS, failure information associated with the indirect path switch via the direct path in response to receiving the sidelink reconfiguration failure message or the expiry of the timer for sidelink reconfiguration.

Some embodiments of the present disclosure provide a UE. The UE may include at least one memory; and at least one processor coupled with the at least one memory and configured to cause the UE to: connect to a BS via a direct path; and transmit, to the BS, information associated with one or more candidate relay nodes, wherein the information associated with the one or more candidate relay nodes may indicate an ID of a first relay node and an ID of a cell serving the first relay node, the first relay node is in an idle mode or an inactive mode with the BS.

In some embodiments of the present disclosure, the UE and the first relay node connect to each other using a non-3rd generation partnership project (3GPP) access technology.

In some embodiments of the present disclosure, the ID of the first relay node may include one of the following: an ID of the first relay node assigned by an application layer of the first relay node; a random value generated by the first relay node; an ID of the first relay node assigned by a core network; or a resume identify of the first relay node in the case that the first relay node is in an inactive mode with the BS.

In some embodiments of the present disclosure, the at least one processor is further configured to cause the UE to: establish an indirect path to the BS via the first relay node; and transmit information associated with a second relay node to the BS in response to the indirect path being established, wherein the UE and the second relay node connect to each other via a non-3GPP link and a channel quality of the non-3GPP link is greater than or equal to a threshold.

In some embodiments of the present disclosure, the at least one processor is further configured to cause the UE to: establish an indirect path to the BS via the first relay node; detect a failure in the indirect path or receive a notification message or a release message from the first relay node; and transmit information associated with a second relay node to the BS in response to detecting the failure in the indirect path or receiving the notification message or the release message.

In some embodiments of the present disclosure, the at least one processor is further configured to cause the UE to: establish an indirect path to the BS via the first relay node; detect a failure in the indirect path or receive a notification message or a release message from the first relay node; and transmit failure information associated with the indirect path to the BS in response to detecting the failure in the indirect path or receiving the notification message or the release message.

In some embodiments of the present disclosure, the failure information may include the information associated with a second relay node, wherein the UE and the second relay node connect to each other via a non-3GPP link.

In some embodiments of the present disclosure, the at least one processor is further configured to cause the UE to: establish an indirect path to the BS via the first relay node; and transmit, to the BS, information associated with a second relay node and an indicator indicating whether to switch from the first relay node to the second relay node in response to the indirect path being established, wherein the UE and the second relay node connect to each other via a non-3GPP link.

In some embodiments of the present disclosure, the at least one processor is further configured to cause the UE to: establish an indirect path to the BS via the first relay node; and transmit information associated with a second relay node to the BS in response to a condition being met, wherein the UE and the second relay node connect to each other via a non-3GPP link and the condition may include a channel quality of the indirect path being lower than a threshold.

Some embodiments of the present disclosure provide a relay node. The relay node may include at least one memory; and at least one processor coupled with the at least one memory and configured to cause the relay node to: camp on a BS, wherein the relay node is in an idle mode or an inactive mode with the BS; transmit, to a UE, an ID of the relay node and an ID of a cell serving the relay node the UE connects to the BS via a direct path; and transmit, to the BS, the ID of the relay node.

In some embodiments of the present disclosure, the ID of the relay node may include one of the following: an ID of the relay node assigned by an application layer of the relay node; a random value generated by the relay node; or a resume identify of the relay node in the case that the relay node is in an inactive mode with the BS.

In some embodiments of the present disclosure, the UE and the relay node connect to each other using non-3GPP access technology.

Some embodiments of the present disclosure provide a BS. The BS may include: at least one memory; and at least one processor coupled with the at least one memory and configured to cause the BS to: receive, from a UE, information associated with one or more candidate relay nodes, wherein the UE connects to the BS via a direct path, the information associated with the one or more candidate relay nodes may indicate an ID of a first relay node and an ID of a cell serving the first relay node, the first relay node is in an idle mode or an inactive mode with the BS; and transmit, to the UE, a multipath configuration, wherein the multipath may include the direct path and an indirect path to the BS via the first relay node.

In some embodiments of the present disclosure, the UE and the first relay node connect to each other using non-3GPP access technology.

In some embodiments of the present disclosure, the ID of the first relay node may include one of the following: an ID of the first relay node assigned by an application layer of the first relay node; a random value generated by the first relay node; an ID of the first relay node assigned by a core network; or a resume identify of the first relay node in the case that the first relay node is in an inactive mode with the BS.

In some embodiments of the present disclosure, the at least one processor is further configured to cause the BS to receive the ID of the first relay node from the first relay node, and the ID of the first relay node may include one of the following: an ID of the first relay node assigned by an application layer of the first relay node; a random value generated by the first relay node; or a resume identify of the first relay node in the case that the first relay node is in an inactive mode with the BS.

In some embodiments of the present disclosure, the at least one processor is further configured to cause the BS to: establish the indirect path with the UE in response to transmitting the multipath configuration; and receive information associated with a second relay node from the UE in response to the indirect path being established, wherein the UE and the second relay node connect to each other via a non-3GPP link and a channel quality of the non-3GPP link is greater than or equal to a threshold.

In some embodiments of the present disclosure, the at least one processor is further configured to cause the BS to determine whether to switch the UE from the first relay node to the second relay node.

In some embodiments of the present disclosure, the at least one processor is further configured to cause the BS to: store the second relay node as a candidate relay node for the UE; receive information associated with a third relay node from the UE, wherein the UE and the third relay node connect to each other via a non-3GPP link; and replace the second relay node with the third relay node as the candidate relay node for the UE.

In some embodiments of the present disclosure, the at least one processor is further configured to cause the BS to: establish the indirect path with the UE in response to transmitting the multipath configuration; receive, from the UE, information associated with a second relay node or failure information associated with the indirect path; and determine a failure in the indirect path in response to receiving the information associated with the second relay node or the failure information.

In some embodiments of the present disclosure, the failure information may include the information associated with the second relay node.

In some embodiments of the present disclosure, the at least one processor is further configured to cause the BS to indicate to the UE to switch from the first relay node to the second relay node.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system in accordance with some embodiments of the present disclosure;

FIG. 2 illustrates a flowchart of a method for sidelink reconfiguration in accordance with some embodiments of the present disclosure;

FIGS. 3-8 illustrate flowcharts of methods for wireless communication in accordance with some embodiments of the present disclosure;

FIGS. 9-11 illustrate flowcharts of methods for wireless communication performed by a UE in accordance with some embodiments of the present disclosure;

FIG. 12 illustrates a flowchart of a method for wireless communication performed by a relay node in accordance with some embodiments of the present disclosure;

FIG. 13 illustrates a flowchart of a method for wireless communication performed by a network equipment (NE) in accordance with some embodiments of the present disclosure;

FIG. 14 illustrates an example of a UE in accordance with some embodiments of the present disclosure;

FIG. 15 illustrates an example of a processor in accordance with some embodiments of the present disclosure; and

FIG. 16 illustrates an example of an NE in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G NR or 6G, 3GPP LTE, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

In a communication system, a UE may access a BS via multipath including a direct path and an indirect path through a relay node (e.g., another UE). Solutions are desired to facilitate the implementation of such multipath. For example, solutions are desired to facilitate the failure handling, path addition and path switch in a multipath scenario.

The present disclosure provides solutions to solve the above issues. For example, embodiments that can facilitate the failure handling, path addition and path switch in a multipath scenario are provided.

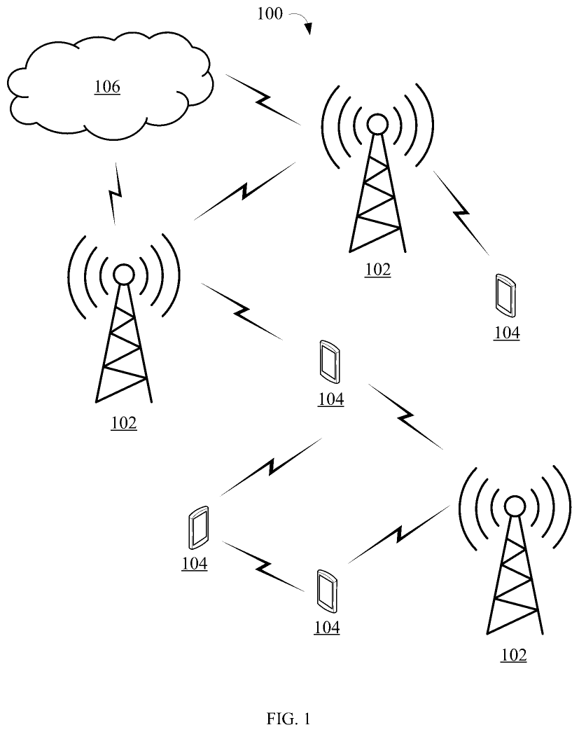

FIG. 1 illustrates a schematic diagram of wireless communication system 100 in accordance with some embodiments of the present disclosure.

The wireless communication system 100 may include one or more NEs 102 (e.g., one or more BSs), one or more UEs 104, and a core network (CN) 106. The wireless communication system 100 may support various radio access technologies. In some implementations, the wireless communication system 100 may be a 4G network, such as an LTE network or an LTE-Advanced (LTE-A) network. In some other implementations, the wireless communication system 100 may be a NR network, such as a 5G network, a 5G-Advanced (5G-A) network, or a 5G ultra-wideband (5G-UWB) network. In other implementations, the wireless communication system 100 may be a combination of a 4G network and a 5G network, or other suitable radio access technology including Institute of Electrical and Electronics Engineers (IEEE) 802.11 (Wi-Fi), IEEE 802.16 (WiMAX), and IEEE 802.20. The wireless communication system 100 may support radio access technologies beyond 5G, for example, 6G. Additionally, the wireless communication system 100 may support technologies, such as time division multiple access (TDMA), frequency division multiple access (FDMA), or code division multiple access (CDMA), etc.

The one or more NEs 102 may be dispersed throughout a geographic region to form the wireless communication system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with a different NE 102.

The one or more UEs 104 may be dispersed throughout a geographic region of the wireless communication system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A relaying function based on a sidelink may be supported in the wireless communication system 100. For example, a UE 104 supporting sidelink communication may function as a relay node to extend the coverage of an NE 102 (e.g., a BS). An out-of-coverage or in-coverage UE may communicate with a BS via a relay node (e.g., a relay UE). In some implementations, a UE, which functions as a relay between another UE and a BS, may be referred to as a UE-to-network (U2N) relay.

An NE 102 may support communication with the CN 106, or with another NE 102, or both. For example, an NE 102 may interface with another NE 102 or the CN 106 through one or more backhaul links (e.g., S1, N2, N3, or network interface). In some implementations, the NE 102 may communicate with each other directly. In some other implementations, the NE 102 may communicate with each other or indirectly (e.g., via the CN 106. In some implementations, one or more NEs 102 may include subcomponents, such as an access network entity, which may be an example of an access node controller (ANC). An ANC may communicate with the one or more UEs 104 through one or more other access network transmission entities, which may be referred to as radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N3, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communication system 100, the NEs 102 and the UEs 104 may use resources of the wireless communication system 100 (e.g., time resources (e.g., symbols, slots, subframes, frames, or the like) or frequency resources (e.g., subcarriers, carriers)) to perform various operations (e.g., wireless communication). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communication system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communication system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., orthogonal frequency-division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communication system 100, an electromagnetic (EM) spectrum may be split, based on frequency or wavelength, into various classes, frequency bands, frequency channels, etc. By way of example, the wireless communication system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communication over one or more of the operating frequency bands. In some implementations, FR1 may be used by the NEs 102 and the UEs 104, among other equipment or devices for cellular communication traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A UE 104 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, a UE 104 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, a UE 104 includes wearable devices, such as smart watches, fitness bands, optical head-mounted displays, or the like. Moreover, a UE 104 may be referred to as a subscriber unit, a mobile, a mobile station, a user, a terminal, a mobile terminal, a wireless terminal, a fixed terminal, a subscriber station, a user terminal, or a device, or described using other terminology used in the art. A UE 104 may communicate with an NE 102 (e.g., a BS) via uplink (UL) communication signals. An NE 102 may communicate with a UE 104 via downlink (DL) communication signals.

In some embodiments of the present disclosure, an NE 102 and a UE 104 may communicate over licensed spectrums, whereas in some other embodiments, an NE 102 and a UE 104 may communicate over unlicensed spectrums. The present disclosure is not intended to be limited to the implementation of any particular wireless communication system architecture or protocol.

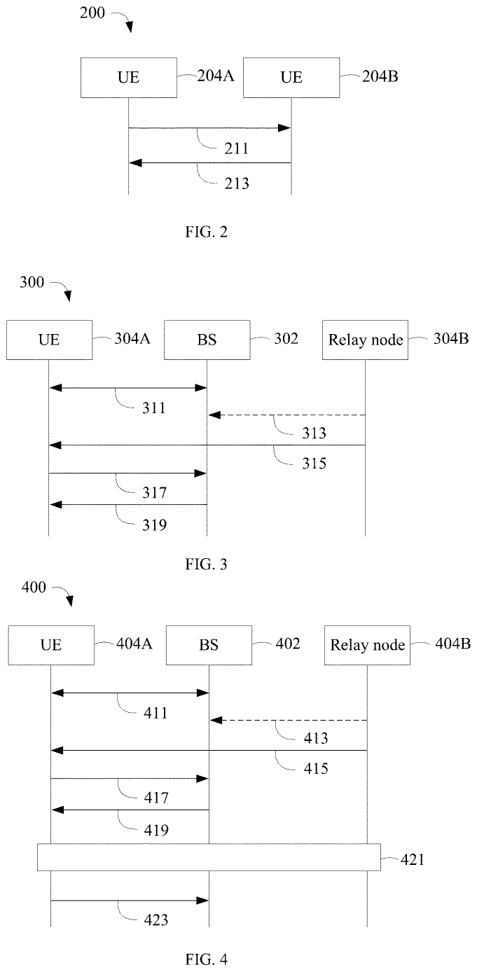

FIG. 2 illustrates a flow chart of method 200 for sidelink reconfiguration in accordance with some embodiments of the present disclosure. Details described in all of the foregoing embodiments of the present disclosure are applicable for the embodiments shown in FIG. 2. For example, UE 204A and UE 204B may function as UE 104 shown in FIG. 1.

Referring to FIG. 2, at 211, UE 204A may transmit a sidelink reconfiguration message to UE 204B. At 213, UE 204B may transmit a sidelink reconfiguration complete message in the case of a successful reconfiguration or a sidelink reconfiguration failure message in the case of a failed reconfiguration in response to receiving the sidelink reconfiguration message.

In some embodiments of the present disclosure, method 200 may be used to modify a PC5-radio resource control (RRC) connection, for example, to establish, modify, or release sidelink data radio bearers (DRBs), to configure sidelink measurement and reporting, or to configure sidelink channel state information (CSI) reference signal resources. For example, a UE may initiate method 200 to establish a PC5 connection with another UE. Method 200 may be referred to as a sidelink reconfiguration procedure.

In some embodiments of the present disclosure, a wireless communication system may support multipath. For example, a UE (also referred to as remote UE) may access an NE (e.g., a BS) via a direct path and an indirect path through a relay node (e.g., another UE). In some embodiments, the communication link between the remote UE and the relay node may conform to 3GPP access technologies (hereinafter, multipath scenario 1). For example, the relay node may be a layer 2 U2N relay. In some embodiments, the communication link between the remote UE and the relay node may conform to non-3GPP access technologies such as Bluetooth or WiFi (hereinafter, multipath scenario 2). In some examples, the connection between the remote UE and the relay node may be assumed to be ideal. In some examples, solutions for multipath scenario 1 can be reused for multipath scenario 2 without precluding the possibility of excluding a part of the solutions which is unnecessary for multipath scenario 2; or vice versa.

Embodiments of the present disclosure propose technical solutions for facilitating the implementation of the multipath in a communication network. For example, solutions for facilitating the failure handling, path addition and path switch in a multipath scenario are provided. More details on the embodiments of the present disclosure will be illustrated in the following text in combination with the appended drawings.

FIG. 3 illustrates a flow chart of exemplary method 300 for wireless communications in accordance with some embodiments of the present disclosure. Details described in all of the foregoing embodiments of the present disclosure are applicable for the embodiments shown in FIG. 3. For example, UE 304A and relay node 304B may function as UE 104 in FIG. 1 or UE 204A or UE 204B in FIG. 2. BS 302 may function as NE 102 shown in FIG. 1.

Referring to FIG. 3, at 311, UE 304A may connect to (or access) BS 302 via a direct path. That is, UE 304A may directly connect to BS 302 without any relay node. One or more relay nodes may camp on BS 302. Some of the one or more relay nodes, for example, relay node 304B, may be in an idle mode or an inactive mode with BS 302. Some other relay nodes may be in a connected mode with BS 302. For example, relay node 304B may be in an RRC_idle state or an RRC_inactive state as specified in 3GPP standards. UE 304A may be in an RRC_connected state as specified in 3GPP standards.

In some embodiments, UE 304A and the relay nodes which are in the connected mode may report a measurement result associated with a neighbor cell(s) or a candidate relay(s). The measurement report may be based on a configuration from BS 302.

At 317, UE 304A may transmit, to BS 302, information associated with one or more candidate relay nodes. In some embodiments, UE 304A and a reported candidate relay node may connect to each other using non-3GPP access technology. In some embodiments, UE 304A and a reported candidate relay node may connect to each other using 3GPP access technology.

In some embodiments, the one or more candidate relay nodes may include one or more relay nodes (denoted as relay node #A) in the connected mode. The information associated with one or more candidate relay nodes may include an ID (e.g., cell radio network temporary identifier (C-RNTI)) of relay node #A and an ID (e.g., NR cell global identifier (NCGI)) of a cell serving relay node #A. Relay node #A may transmit its C-RNTI and the NCGI of its serving cell to UE 304A at 315. In these embodiments, operation 313 can be omitted.

In some embodiments, the one or more candidate relay nodes may include one or more relay nodes (e.g., relay node 304B) in the idle or inactive mode. For example, the information associated with one or more candidate relay nodes may include an ID of relay node 304B and an ID (e.g., NCGI) of a cell serving relay node 304B. An idle or inactive relay node may not have a C-RNTI. The ID of relay node 304B may include one of the following: (1) an ID of relay node 304B assigned by a higher layer (e.g., an application layer) of relay node 304B; (2) a random value generated by relay node 304B; (3) an ID of relay node 304B assigned by a core network; or (4) a resume identify of relay node 304B in the case that relay node 304B is in an inactive mode with BS 302.

Relay node 304B may transmit the ID of relay node 304B to UE 304A at 315, which may be included in an information element (IE). In this way, UE 304A can include the ID of relay node 304B in the information associated with one or more candidate relay nodes at 317.

In some examples, ID (1) assigned by the application layer of relay node 304B may comply with non-3GPP access technology. UE 304A and relay node 304B may connect to each other using the non-3GPP access technology. Relay node 304B may transmit ID (1) to BS 302 at 313 and to UE 304A at 315.

In some examples, relay node 304B may generate the random value (i.e., ID (2)) with a certain length (e.g., 24 or 32 bits), and transmit it to BS 302 at 313 and to UE 304A at 315.

In some examples, ID (3) may be a temporary mobile subscriber identity (TMSI) or other ID of relay node 304B assigned by the core network. Relay node 304B may transmit ID (3) to UE 304A at 315. In these examples, operation 313 can be omitted.

In some examples, ID (4) may be an inactive RNTI (I-RNTI)) of relay node 304B. Relay node 304B may transmit ID (4) to BS 302 at 313 and to UE 304A at 315.

In response to receiving the information associated with one or more candidate relay nodes, BS 302 may configure a multipath for UE 304A. For example, at 319, BS 302 may transmit a multipath configuration to UE 304A. In some embodiments, the multipath may include the direct path and an indirect path to BS 302 via a relay node (e.g., relay node 304B). For example, UE 304A may establish an indirect path to BS 302 via relay node 304B.

In some embodiments, after the multipath to BS 302 has been established, UE 304A may update the candidate relay node. For example, in response to a link failure (e.g., a non-3GPP link failure) is detected for a candidate relay node, UE 304A may update the candidate relay node list (e.g., the information associated with one or more candidate relay nodes as transmitted to BS 302 at 317).

In some embodiments, after the multipath to BS 302 has been established, BS 302 may configure an indirect path change based on the candidate relay node(s) as reported by UE 304A.

It should be appreciated by persons skilled in the art that the sequence of the operations in exemplary method 300 may be changed and some of the operations in exemplary method 300 may be eliminated or modified, without departing from the spirit and scope of the disclosure. For example, operation 313 is denoted by a dotted arrow as an option and may be omitted in certain scenarios.

FIG. 4 illustrates a flow chart of exemplary method 400 for wireless communications in accordance with some embodiments of the present disclosure. Details described in all of the foregoing embodiments of the present disclosure are applicable for the embodiments shown in FIG. 4. For example, UE 404A and relay node 404B may function as UE 104 in FIG. 1 or UE 204A or UE 204B in FIG. 2. BS 402 may function as NE 102 shown in FIG. 1.

Referring to FIG. 4, at 411, UE 404A may connect to (or access) BS 402 via a direct path. That is, UE 404A may directly connect to BS 402 without any relay node. One or more relay nodes may camp on BS 402. Some of the one or more relay nodes, for example, relay node 404B, may be in an idle mode or an inactive mode with BS 402. Some other relay nodes may be in a connected mode with BS 402. For example, relay node 404B may be in an RRC_idle state or an RRC_inactive state. UE 404A may be in an RRC_connected state.

In some embodiments, UE 404A and the relay nodes which are in the connected mode may report a measurement result associated with a neighbor cell(s) or a candidate relay(s). The measurement report may be based on a configuration from BS 402.

At 417, UE 404A may transmit, to BS 402, information associated with one or more candidate relay nodes. In some embodiments, UE 404A and a reported candidate relay node may connect to each other using non-3GPP access technology. In some embodiments, UE 404A and a reported candidate relay node may connect to each other using 3GPP access technology.

In some embodiments, the one or more candidate relay nodes may include one or more relay nodes (denoted as relay node #B) in the connected mode. The information associated with one or more candidate relay nodes may include an ID (e.g., C-RNTI) of relay node #B and an ID (e.g., NCGI) of a cell serving relay node #B. Relay node #B may transmit its C-RNTI and the NCGI of its serving cell to UE 404A at 415. In these embodiments, operation 413 can be omitted.

In some embodiments, the one or more candidate relay nodes may include one or more relay nodes (e.g., relay node 404B) in the idle or inactive mode. For example, the information associated with one or more candidate relay nodes may include an ID of relay node 404B and an ID (e.g., NCGI) of a cell serving relay node 404B. An idle or inactive relay node may not have a C-RNTI. The ID of relay node 404B may include one of the following: (1′) an ID of relay node 404B assigned by a higher layer (e.g., an application layer) of relay node 404B; (2′) a random value generated by relay node 404B; (3′) an ID of relay node 404B assigned by a core network; or (4′) a resume identify of relay node 404B in the case that relay node 404B is in an inactive mode with BS 402.

Relay node 404B may transmit the ID of relay node 404B to UE 404A at 415, which may be included in an IE. In this way, UE 404A can include the ID of relay node 404B in the information associated with one or more candidate relay nodes at 417.

In some examples, ID (1′) assigned by the application layer of relay node 404B may comply with non-3GPP access technology. UE 404A and relay node 404B may connect to each other using the non-3GPP access technology. Relay node 404B may transmit ID (1′) to BS 402 at 413 and to UE 404A at 415. In some examples, relay node 404B may generate the random value (i.e., ID (2′)) with a certain length (e.g., 24 or 42 bits), and transmit it to BS 402 at 413 and to UE 404A at 415. In some examples, ID (3′) may be a TMSI or other ID of relay node 404B assigned by the core network. Relay node 404B may transmit ID (3′) to UE 404A at 415. In these examples, operation 413 can be omitted. In some examples, ID (4′) may be an I-RNTI of relay node 404B. Relay node 404B may transmit ID (4′) to BS 402 at 413 and to UE 404A at 415.

In response to receiving the information associated with one or more candidate relay nodes, BS 402 may configure a multipath for UE 404A. For example, at 419, BS 402 may transmit a multipath configuration to UE 404A. In some embodiments, the multipath may include the direct path and an indirect path to BS 402 via a relay node (e.g., relay node 404B). For example, at 421, UE 404A may establish an indirect path to BS 402 via relay node 404B in response to receiving the multipath configuration.

In some embodiments, in response to the indirect path or the multipath being established (e.g., after the multipath to BS 402 has been established), UE 404A may transmit information associated with a candidate relay node (e.g., one or more candidate relay node such as relay node #C (not shown in FIG. 4)) to BS 402 at 423. In some embodiments, information associated with relay node #C may include an ID of relay node #C and an ID (e.g., NCGI) of a cell serving relay node #C. Relay node #C may be in a connected, idle, or inactive mode with BS 402. The descriptions regarding the ID of a relay node in the foregoing embodiments can be applied to the ID of relay node #C. In some embodiments, UE 404A and relay node #C may connect to each other via a non-3GPP link. In some embodiments, UE 404A and relay node #C may connect to each other via a 3GPP link.

For example, in some embodiments, UE 404A may determine that the channel quality of the link (e.g., a non-3GPP link) between UE 404A and relay node #C is good (e.g., the channel quality is greater than or equal to a threshold). UE 404A may transmit information associated with relay node #C to BS 402 at 423. In response to receiving the information associated with relay node #C, BS 402 would not consider that the current link between UE 404A and relay node 404B is poor or fails. In some embodiments, BS 402 can determine whether to switch UE 404A from relay node 404B to another relay node based on the load and other factors.

In some embodiments, BS 402 may relay node #C as a candidate relay node for UE 404A. For example, in the case that BS 402 determines to switch UE 404A from relay node 404B to another relay node, BS 402 may instruct UE 404A to switch to relay node #C. In some embodiments, after indicating relay node #C to BS 402, UE 404A may transmit information associated with another relay node (e.g., relay node #D) to BS 402. In some embodiments, UE 404A and relay node #D may connect to each other via a non-3GPP link. In some embodiments, UE 404A and relay node #D may connect to each other via a 3GPP link. BS 402 may replace relay node #C with relay node #D as the candidate relay node for UE 404A. For example, after receiving information associated with relay node #D, in the case that BS 402 determines to switch UE 404A from relay node 404B to another relay node, BS 402 may instruct UE 404A to switch to relay node #D.

In some embodiments, a failure may occur on the indirect path to BS 402 via relay node 404B. For example, after the indirect path or the multipath to BS 402 has been established, UE 404A may detect a failure in the indirect path (e.g., a failure in the non-3GPP link between UE 404A and relay node 404B) or UE 404A may receive a notification message or a release message from relay node 404B.

In some embodiments, in response to detecting the failure in the indirect path or receiving the notification message or the release message, UE 404A may transmit information associated with relay node #C to BS 402 at 423. In response to receiving the information associated with relay node #C, BS 402 may consider that the current link between UE 404A and relay node 404B fails. That is, BS 402 may determine that a failure occurs in the indirect path of UE 404A. In some embodiments, BS 402 may indicate to UE 404A to switch from relay node 404B to another relay node (e.g., relay node #C).

In some embodiments, in response to detecting the failure in the indirect path or receiving the notification message or the release message, UE 404A may transmit failure information (or a failure report) associated with the indirect path to BS 402 at 423. In response to receiving the failure information, BS 402 may consider that the current link between UE 404A and relay node 404B fails. That is, BS 402 may determine that a failure occurs in the indirect path of UE 404A. In some embodiments, the failure information may the information associated with relay node #C. In some embodiments, BS 402 may indicate to UE 404A to switch from relay node 404B to another relay node (e.g., relay node #C).

In some embodiments, in addition to transmitting information associated with relay node #C to BS 402 at 423, UE 404A may also transmit an indicator indicating whether to perform an indirect path switch (e.g., switching from relay node 404B to relay node #C) node at 423. BS 402 may determine whether to instruct UE 404A to perform an indirect path switch based on the indicator.

In some embodiments, UE 404A may transmit information associated with relay node #C to BS 402 in response to a condition being met. For example, in response to the channel quality of the indirect path being lower than a threshold (e.g., the channel quality of the link between UE 404A and relay node 404B is lower than a threshold), UE 404A may transmit information associated with relay node #C to BS 402 at 423. In response to receiving the information associated with relay node #C, BS 402 may consider that the current link between UE 404A and relay node 404B is poor or fails. That is, BS 402 may determine that a failure occurs in the indirect path of UE 404A. In some embodiments, BS 402 may instruct UE 404A to switch from relay node 404B to another relay node (e.g., relay node #C).

It should be appreciated by persons skilled in the art that the sequence of the operations in exemplary method 400 may be changed and some of the operations in exemplary method 400 may be eliminated or modified, without departing from the spirit and scope of the disclosure. For example, operation 413 is denoted by a dotted arrow as an option and may be omitted in certain scenarios.

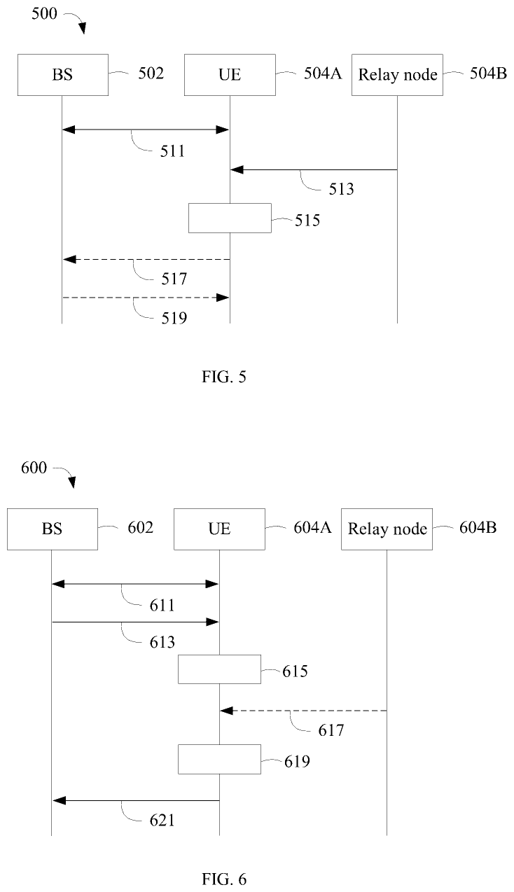

FIG. 5 illustrates a flow chart of exemplary method 500 for wireless communications in accordance with some embodiments of the present disclosure. Details described in all of the foregoing embodiments of the present disclosure are applicable for the embodiments shown in FIG. 5. For example, UE 504A and relay node 504B may function as UE 105 in FIG. 1 or UE 204A or UE 204B in FIG. 2. BS 502 may function as NE 102 shown in FIG. 1.

Referring to FIG. 5, at 511, UE 504A may connect to (or access) BS 502. In some embodiments, UE 504A may be configured with multipath. For example, UE 504A may connect to BS 502 via multiple paths including an indirect path through relay node 504B and a direct path. In some embodiments, UE 504A may report a measurement result associated with a neighbor cell(s) or a candidate relay(s). The measurement report may be based on a configuration from BS 502.

At 513, UE 504A may receive a notification message or a PC5-S release message from relay node 504B. Relay node 504B may transmit the notification message or the PC5-S release message due to a Uu link failure, a handover, a cell reselection, a connection establishment failure or a connection resume failure of relay node 504B.

In some embodiments, in response to receiving the PC5-S release message, a higher layer (e.g., the PC5-S layer) of UE 504A may, at 515, indicate a release of the PC5 unicast link between UE 504A and relay node 504B to an access stratum (AS) layer of UE 504A.

In some embodiments, in response to the direct path being not suspended (e.g., the master cell group (MCG) being not suspended), UE 504A may report failure information associated with the indirect path via the direct path to BS 502 at 517. In some embodiments, the failure information may indicate a reception of the notification message or the PC5-S release message. In response to receiving the failure information, BS 502 may, at 519, configure UE 504A to perform a (candidate) relay node change.

In some embodiments, in response to the direct path being suspended (e.g., the MCG being suspended), UE 504A may perform a reestablishment procedure. In these embodiments, operations 517 and 519 can be omitted.

It should be appreciated by persons skilled in the art that the sequence of the operations in exemplary method 500 may be changed and some of the operations in exemplary method 500 may be eliminated or modified, without departing from the spirit and scope of the disclosure. For example, operations 517 and 519 are denoted by dotted arrows as an option and may be omitted in certain scenarios.

FIG. 6 illustrates a flow chart of exemplary method 600 for wireless communications in accordance with some embodiments of the present disclosure. Details described in all of the foregoing embodiments of the present disclosure are applicable for the embodiments shown in FIG. 6. For example, UE 604A and relay node 604B may function as UE 106 in FIG. 1 or UE 204A or UE 204B in FIG. 2. BS 602 may function as NE 102 shown in FIG. 1.

Referring to FIG. 6, at 611, UE 604A may connect to (or access) BS 602. In some embodiments, UE 604A may be configured with multipath. For example, UE 604A may connect to BS 602 via multiple paths including an indirect path (denoted as indirect path #1) through a relay node (denoted as relay node #E) and a direct path. In some embodiments, UE 604A may report a measurement result associated with a neighbor cell(s) or a candidate relay(s). The measurement report may be based on a configuration from BS 602.

BS 602 may determine to switch the indirect path of UE 604A. At 613, BS 602 may transmit a reconfiguration message instructing UE 604A to perform an indirect path switch (e.g., switch from indirect path #1 to another indirect path (denoted as indirect path #2)). The reconfiguration message may indicate a target relay node (e.g., relay node 604B) of indirect path #2. That is, BS 402 may instruct UE 604A to switch from relay node #E to relay node 604B.

In response to receiving the reconfiguration message, UE 604A may, at 615, start a timer for indirect path switch (denoted as timer #A1) and perform an indirect path switch procedure towards relay node 604B. Since timer #A1 is employed for indirect path switch in a multipath scenario, it may also be referred to as a timer for indirect path change in a multipath scenario or other similar wording that can be conceived of by persons skilled in the art.

In some embodiments, in response to performing the indirect path switch procedure, UE 604A may release the source relay node (e.g., relay node #E). For example, UE 604A may initiate method 200 with respect to relay node #E.

In some embodiments, during the indirect path switch procedure, UE 604A may, at 617 (denoted by a dotted arrow as an option), receive a notification message or a PC5-S release message from relay node 604B. Relay node 604B may transmit the notification message or the PC5-S release message due to a Uu link failure, a handover, a cell reselection, a connection establishment failure, or a connection resume failure of relay node 604B. For example, when relay node 604B is in a connected mode, a Uu link failure or a handover may occur. For example, when relay node 604B is in an idle or inactive mode, it may be triggered by the indirect path switch procedure to perform a connection establishment or resume which may fail. Alternatively, UE 604A may detect a sidelink RLF between UE 604A and relay node 604B.

In some embodiments, in response to receiving the notification message or the PC5-S release message or detecting the sidelink RLF, UE 604A may stop timer #A1 at 619. In some embodiments, in response to receiving the notification message or the PC5-S release message or detecting the sidelink RLF, UE 604A may, at 621, transmit failure information associated with the indirect path switch to BS 402 via the direct path.

In some embodiments, in response to receiving the notification message or the PC5-S release message or detecting the sidelink RLF, UE 604A may determine that timer #A1 is expired at 619 (although timer #A1 is not actually expired). The UE 604A may behave accordingly for the timer expiration. For example, in response to receiving the notification message or the PC5-S release message or detecting the sidelink RLF, UE 604A may, at 621, transmit failure information associated with the indirect path switch to BS 402 via the direct path.

It should be appreciated by persons skilled in the art that the sequence of the operations in exemplary method 600 may be changed and some of the operations in exemplary method 600 may be eliminated or modified, without departing from the spirit and scope of the disclosure. For example, operation 617 is denoted by dotted arrows as an option and may be omitted in certain scenarios.

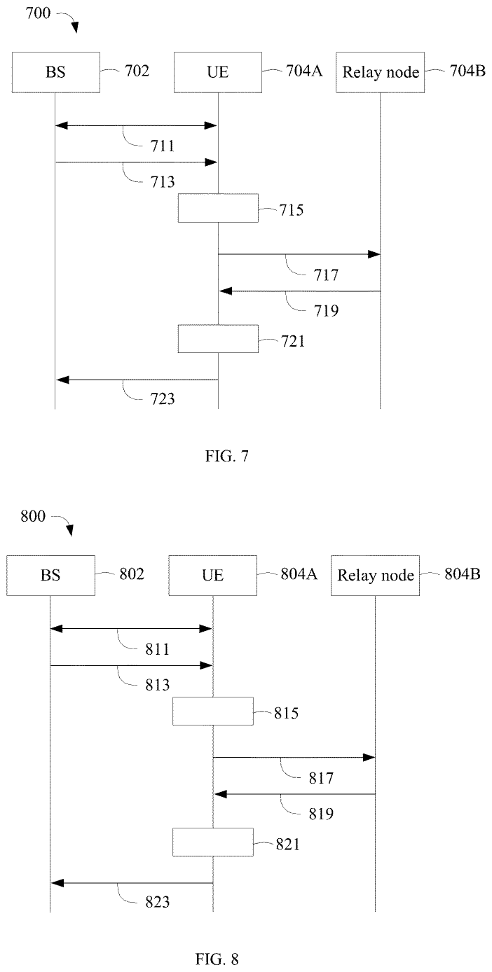

FIG. 7 illustrates a flow chart of exemplary method 700 for wireless communications in accordance with some embodiments of the present disclosure. Details described in all of the foregoing embodiments of the present disclosure are applicable for the embodiments shown in FIG. 7. For example, UE 704A and relay node 704B may function as UE 107 in FIG. 1 or UE 204A or UE 204B in FIG. 2. BS 702 may function as NE 102 shown in FIG. 1.

Referring to FIG. 7, at 711, UE 704A may connect to (or access) BS 702. In some embodiments, UE 704A may be configured with multipath. For example, UE 704A may connect to BS 702 via multiple paths including an indirect path (denoted as indirect path #1′) through a relay node (denoted as relay node #F) and a direct path. In some embodiments, UE 704A may report a measurement result associated with a neighbor cell(s) or a candidate relay(s). The measurement report may be based on a configuration from BS 702.

BS 702 may determine to switch the indirect path of UE 704A. At 713, BS 702 may transmit a reconfiguration message instructing UE 704A to perform an indirect path switch (e.g., switch from indirect path #1′ to another indirect path (denoted as indirect path #2′)). The reconfiguration message may indicate a target relay node (e.g., relay node 704B) of indirect path #2′. That is, BS 402 may instruct UE 704A to switch from relay node #F to relay node 704B.

In response to receiving the reconfiguration message, UE 704A may, at 715, start a timer for indirect path switch (denoted as timer #B1) and perform an indirect path switch procedure towards relay node 704B. Since timer #B1 is employed for indirect path switch in a multipath scenario, it may also be referred to as a timer for indirect path change in a multipath scenario or other similar wording that can be conceived of by persons skilled in the art.

In some embodiments, in response to performing the indirect path switch procedure, UE 704A may release the source relay node (e.g., relay node #F). For example, UE 704A may initiate method 200 with respect to relay node #F.

In some embodiments, in response to performing the indirect path switch procedure, UE 704A may start a timer for sidelink reconfiguration (e.g., timer T400 as specified in 3GPP standards). For example, UE 704A may initiate method 200 with respect to relay node 704B. For example, at 717, UE 704A may transmit a sidelink reconfiguration message to relay node 704B. In some embodiments, in response to transmitting the sidelink reconfiguration message, UE 704A may start the timer for sidelink reconfiguration.

In some embodiments, in response to transmitting the sidelink reconfiguration message, UE 704A may receive a sidelink reconfiguration complete message from relay node 704B. In some embodiments, UE 704A may stop timer #B1 in response to the PC5-RRC connection establishment between UE 704A and relay node 704B being completed or in response to UE 704A transmitting a reconfiguration complete message to BS 702 (e.g., via relay node 704B).

In some embodiments, in response to transmitting the sidelink reconfiguration message, UE 704A may receive a sidelink reconfiguration failure message from relay node 704B at 719.

In some embodiments, UE 704A may stop timer #B1 at 721 in response to receiving the sidelink reconfiguration failure message. At 723, UE 704A may further transmit failure information associated with the indirect path switch to BS 702 via the direct path in response to receiving the sidelink reconfiguration failure message.

In some embodiments, UE 704A may stop timer #B1 at 721 in response to the expiry of the timer for sidelink reconfiguration (e.g., timer T400). At 723, UE 704A may further transmit failure information associated with the indirect path switch to BS 702 via the direct path in response to the expiry of the timer for sidelink reconfiguration.

It should be appreciated by persons skilled in the art that the sequence of the operations in exemplary method 700 may be changed and some of the operations in exemplary method 700 may be eliminated or modified, without departing from the spirit and scope of the disclosure.

FIG. 8 illustrates a flow chart of exemplary method 800 for wireless communications in accordance with some embodiments of the present disclosure. Details described in all of the foregoing embodiments of the present disclosure are applicable for the embodiments shown in FIG. 8. For example, UE 804A and relay node 804B may function as UE 108 in FIG. 1 or UE 204A or UE 204B in FIG. 2. BS 802 may function as NE 102 shown in FIG. 1.

Referring to FIG. 8, at 811, UE 804A may connect to (or access) BS 802. For example, UE 804A may connect to BS 802 via a direct path. In some embodiments, UE 804A may report a measurement result associated with a neighbor cell(s) or a candidate relay(s). The measurement report may be based on a configuration from BS 802.

BS 802 may determine to perform an indirect path addition for UE 804A. At 813, BS 802 may transmit a reconfiguration message instructing UE 804A to perform an indirect path addition. For example, the reconfiguration message may indicate a target relay node (e.g., relay node 804B) of the indirect path.

In response to receiving the reconfiguration message, UE 804A may, at 815, start a timer for an indirect path addition (denoted as timer #C1) and perform an indirect path addition procedure towards relay node 804B. Since timer #C1 is employed for an indirect path addition in a multipath scenario, it may also be referred to as a timer for an indirect path addition in a multipath scenario or other similar wording that can be conceived of by persons skilled in the art. In some embodiments, the timer for the indirect path addition may be the same timer as the timer for the indirect path switch as described above.

In some embodiments, in response to performing the indirect path addition procedure, UE 804A may start a timer for sidelink reconfiguration (e.g., timer T400 as specified in 3GPP standards). For example, UE 804A may initiate method 200 with respect to relay node 804B. For example, at 817, UE 804A may transmit a sidelink reconfiguration message to relay node 804B. In some embodiments, in response to transmitting the sidelink reconfiguration message, UE 804A may start the timer for sidelink reconfiguration.

In some embodiments, in response to transmitting the sidelink reconfiguration message, UE 804A may receive a sidelink reconfiguration complete message from relay node 804B. In some embodiments, UE 804A may stop timer #C1 in response to the PC5-RRC connection establishment between UE 804A and relay node 804B being completed or in response to UE 804A transmitting a reconfiguration complete message to BS 802 (e.g., via relay node 804B).

In some embodiments, in response to transmitting the sidelink reconfiguration message, UE 804A may receive a sidelink reconfiguration failure message from relay node 804B at 819.

In some embodiments, UE 804A may stop timer #C1 at 821 in response to receiving the sidelink reconfiguration failure message. At 823, UE 804A may further transmit failure information associated with the indirect path addition to BS 802 via the direct path in response to receiving the sidelink reconfiguration failure message.

In some embodiments, UE 804A may stop timer #C1 at 821 in response to the expiry of the timer for sidelink reconfiguration (e.g., timer T400). At 823, UE 804A may further transmit failure information associated with the indirect path addition to BS 802 via the direct path in response to the expiry of the timer for sidelink reconfiguration.

It should be appreciated by persons skilled in the art that the sequence of the operations in exemplary method 800 may be changed and some of the operations in exemplary method 800 may be eliminated or modified, without departing from the spirit and scope of the disclosure.

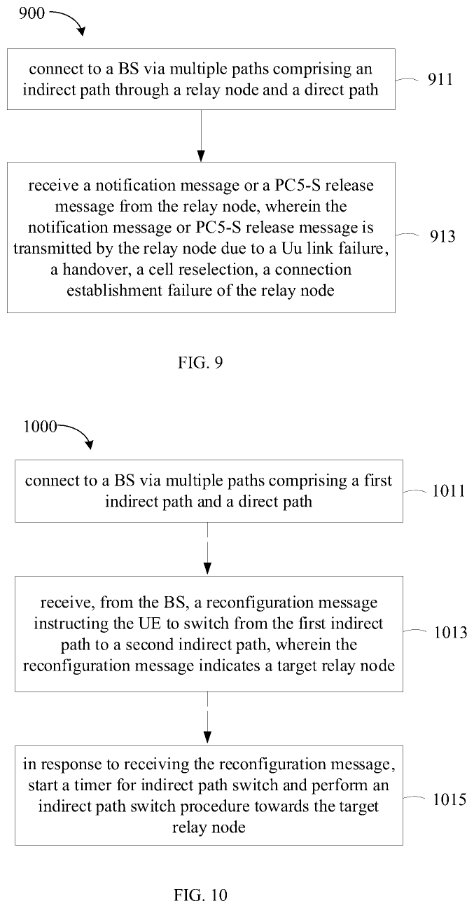

FIG. 9 illustrates a flowchart of method 900 for wireless communication in accordance with some embodiments of the present disclosure. Details described in all of the foregoing embodiments of the present disclosure are applicable for the embodiments shown in FIG. 9. In some examples, method 900 may be performed by a UE, for example, UE 104 as described with reference to FIG. 1 or UE 204A or UE 204B as described with reference FIG. 2. In some embodiments, the UE may execute a set of instructions to control the functional elements of the UE to perform the described functions or operations.

At 911, the UE may connect to a BS via multiple paths comprising an indirect path through a relay node and a direct path. At 913, the UE may receive a notification message or a PC5-S release message from the relay node, wherein the notification message or PC5-S release message is transmitted by the relay node due to a Uu link failure, a handover, a cell reselection, a connection establishment failure of the relay node.

In some embodiments of the present disclosure, the UE may indicate, from a PC5-S layer of the UE to an AS layer of the UE, a release of a PC5 unicast link between the UE and the relay node in response to receiving the PC5-S release message.

In some embodiments of the present disclosure, the UE may report failure information associated with the indirect path via the direct path in response to the direct path being not suspended. In some embodiments of the present disclosure, the UE may perform a reestablishment procedure in response to the direct path being suspended. In some embodiments of the present disclosure, the failure information may indicate a reception of the notification message or the PC5-S release message.

It should be appreciated by persons skilled in the art that the sequence of the operations in exemplary method 900 may be changed and some of the operations in exemplary method 900 may be eliminated or modified, without departing from the spirit and scope of the disclosure.

FIG. 10 illustrates a flowchart of method 1000 for wireless communication in accordance with some embodiments of the present disclosure. Details described in all of the foregoing embodiments of the present disclosure are applicable for the embodiments shown in FIG. 10. In some examples, method 1000 may be performed by a UE, for example, UE 104 as described with reference to FIG. 1 or UE 204A or UE 204B as described with reference FIG. 2. In some embodiments, the UE may execute a set of instructions to control the functional elements of the UE to perform the described functions or operations.

At 1011, the UE may connect to a BS via multiple paths comprising a first indirect path and a direct path. At 1013, the UE may receive, from the BS, a reconfiguration message instructing the UE to switch from the first indirect path to a second indirect path, wherein the reconfiguration message may indicate a target relay node. At 1015, the UE may start a timer for indirect path switch and perform an indirect path switch procedure towards the target relay node in response to receiving the reconfiguration message.

In some embodiments of the present disclosure, the UE may, during the indirect path switch procedure, receive a notification message or a PC5-S release message from the target relay node or detect a sidelink RLF between the UE and the target relay node.

In some embodiments of the present disclosure, the UE may stop the timer for indirect path switch or determine that the timer for indirect path switch is expired in response to receiving the notification message or the PC5-S release message or detecting the sidelink RLF.

In some embodiments of the present disclosure, the UE may transmit, to the BS, failure information associated with indirect path switch via the direct path in response to receiving the notification message or the PC5-S release message or detecting the sidelink RLF.

In some embodiments of the present disclosure, the UE may: transmit a sidelink reconfiguration message to the target relay node; receive a sidelink reconfiguration failure message from the target relay node in response to transmitting the sidelink reconfiguration message; and stop the timer for indirect path switch in response to receiving the sidelink reconfiguration failure message.

In some embodiments of the present disclosure, the UE may: start a timer for sidelink reconfiguration in response to performing the indirect path switch procedure; and stop the timer for indirect path switch in response to the expiry of the timer for sidelink reconfiguration.

In some embodiments of the present disclosure, the UE may transmit, to the BS, failure information associated with the indirect path switch via the direct path in response to receiving the sidelink reconfiguration failure message or the expiry of the timer for sidelink reconfiguration.

It should be appreciated by persons skilled in the art that the sequence of the operations in exemplary method 1000 may be changed and some of the operations in exemplary method 1000 may be eliminated or modified, without departing from the spirit and scope of the disclosure.

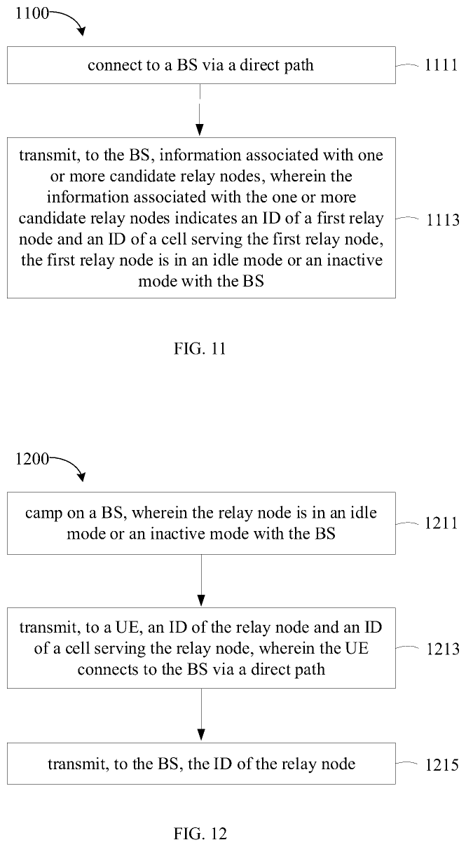

FIG. 11 illustrates a flowchart of method 1100 for wireless communication in accordance with some embodiments of the present disclosure. Details described in all of the foregoing embodiments of the present disclosure are applicable for the embodiments shown in FIG. 11. In some examples, method 1100 may be performed by a UE, for example, UE 104 as described with reference to FIG. 1 or UE 204A or UE 204B as described with reference FIG. 2. In some embodiments, the UE may execute a set of instructions to control the functional elements of the UE to perform the described functions or operations.

At 1111, the UE may connect to a BS via a direct path. At 1113, the UE may transmit, to the BS, information associated with one or more candidate relay nodes, wherein the information associated with the one or more candidate relay nodes may indicate an ID of a first relay node and an ID of a cell serving the first relay node, the first relay node is in an idle mode or an inactive mode with the BS.

In some embodiments of the present disclosure, the UE and the first relay node may connect to each other using non-3GPP access technology.

In some embodiments of the present disclosure, the ID of the first relay node may include one of the following: an ID of the first relay node assigned by an application layer of the first relay node; a random value generated by the first relay node; an ID of the first relay node assigned by a core network; or a resume identify of the first relay node in the case that the first relay node is in an inactive mode with the BS.

In some embodiments of the present disclosure, the UE may: establish an indirect path to the BS via the first relay node; and transmit information associated with a second relay node to the BS in response to the indirect path being established, wherein the UE and the second relay node may connect to each other via a non-3GPP link and a channel quality of the non-3GPP link is greater than or equal to a threshold.

In some embodiments of the present disclosure, the UE may: establish an indirect path to the BS via the first relay node; detect a failure in the indirect path or receive a notification message or a release message from the first relay node; and transmit information associated with a second relay node to the BS in response to detecting the failure in the indirect path or receiving the notification message or the release message.

In some embodiments of the present disclosure, the UE may: establish an indirect path to the BS via the first relay node; detect a failure in the indirect path or receive a notification message or a release message from the first relay node; and transmit failure information associated with the indirect path to the BS in response to detecting the failure in the indirect path or receiving the notification message or the release message. In some embodiments of the present disclosure, the failure information may include the information associated with a second relay node, wherein the UE and the second relay node may connect to each other via a non-3GPP link.

In some embodiments of the present disclosure, the UE may: establish an indirect path to the BS via the first relay node; and transmit, to the BS, information associated with a second relay node and an indicator indicating whether to switch from the first relay node to the second relay node in response to the indirect path being established, wherein the UE and the second relay node may connect to each other via a non-3GPP link.

In some embodiments of the present disclosure, the UE may: establish an indirect path to the BS via the first relay node; and transmit information associated with a second relay node to the BS in response to a condition being met, wherein the UE and the second relay node may connect to each other via a non-3GPP link and the condition may include a channel quality of the indirect path being lower than a threshold.

It should be appreciated by persons skilled in the art that the sequence of the operations in exemplary method 1100 may be changed and some of the operations in exemplary method 1100 may be eliminated or modified, without departing from the spirit and scope of the disclosure.

FIG. 12 illustrates a flowchart of method 1200 for wireless communication in accordance with some embodiments of the present disclosure. Details described in all of the foregoing embodiments of the present disclosure are applicable for the embodiments shown in FIG. 12. In some examples, method 1200 may be performed by a relay node, for example, UE 104 as described with reference to FIG. 1 or UE 204A or UE 204B as described with reference FIG. 2. In some embodiments, the relay node may execute a set of instructions to control the functional elements of the UE to perform the described functions or operations.

At 1211, the relay node may camp on a BS, wherein the relay node is in an idle mode or an inactive mode with the BS. At 1213, the relay node may transmit, to a UE, an ID of the relay node and an ID of a cell serving the relay node, wherein the UE connects to the BS via a direct path. At 1215, the relay node may transmit, to the BS, the ID of the relay node.

In some embodiments of the present disclosure, the ID of the relay node may include one of the following: an ID of the relay node assigned by an application layer of the relay node; a random value generated by the relay node; or a resume identify of the relay node in the case that the relay node is in an inactive mode with the BS.

In some embodiments of the present disclosure, the UE and the relay node may connect to each other using non-3GPP access technology.

It should be appreciated by persons skilled in the art that the sequence of the operations in exemplary method 1200 may be changed and some of the operations in exemplary method 1200 may be eliminated or modified, without departing from the spirit and scope of the disclosure.

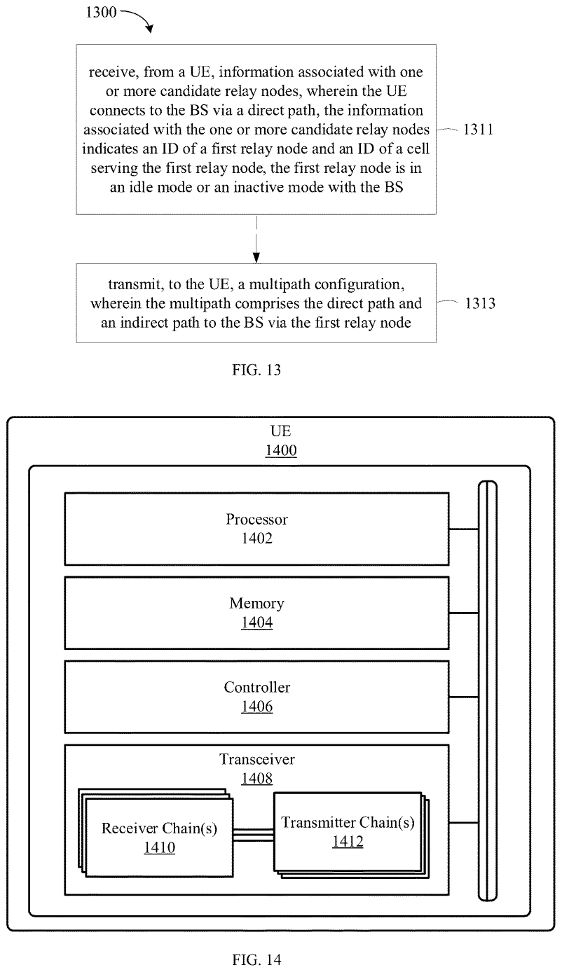

FIG. 13 illustrates a flowchart of method 1300 for wireless communication in accordance with some embodiments of the present disclosure. Details described in all of the foregoing embodiments of the present disclosure are applicable for the embodiments shown in FIG. 13. In some examples, method 1300 may be performed by a BS or an NE (for example, NE 102 as described with reference to FIG. 1). In some embodiments, the BS or the NE may execute a set of instructions to control the functional elements of the BS or the NE to perform the described functions or operations.

At 1311, a BS may receive, from a UE, information associated with one or more candidate relay nodes, wherein the UE connects to the BS via a direct path, the information associated with the one or more candidate relay nodes may indicate an ID of a first relay node and an ID of a cell serving the first relay node, the first relay node is in an idle mode or an inactive mode with the BS. At 1313, the BS may transmit, to the UE, a multipath configuration, wherein the multipath may include the direct path and an indirect path to the BS via the first relay node.

In some embodiments of the present disclosure, the UE and the first relay node connect to each other using non-3GPP access technology.

In some embodiments of the present disclosure, the ID of the first relay node may include one of the following: an ID of the first relay node assigned by an application layer of the first relay node; a random value generated by the first relay node; an ID of the first relay node assigned by a core network; or a resume identify of the first relay node in the case that the first relay node is in an inactive mode with the BS.

In some embodiments of the present disclosure, the BS may receive the ID of the first relay node from the first relay node, and the ID of the first relay node may include one of the following: an ID of the first relay node assigned by an application layer of the first relay node; a random value generated by the first relay node; or a resume identify of the first relay node in the case that the first relay node is in an inactive mode with the BS.

In some embodiments of the present disclosure, the BS may: establish the indirect path with the UE in response to transmitting the multipath configuration; and receive information associated with a second relay node from the UE in response to the indirect path being established, wherein the UE and the second relay node connect to each other via a non-3GPP link and a channel quality of the non-3GPP link is greater than or equal to a threshold.

In some embodiments of the present disclosure, the BS may determine whether to switch the UE from the first relay node to the second relay node.

In some embodiments of the present disclosure, the BS may store the second relay node as a candidate relay node for the UE; receive information associated with a third relay node from the UE, wherein the UE and the third relay node connect to each other via a non-3GPP link; and replace the second relay node with the third relay node as the candidate relay node for the UE.

In some embodiments of the present disclosure, the BS may establish the indirect path with the UE in response to transmitting the multipath configuration; receive, from the UE, information associated with a second relay node or failure information associated with the indirect path; and determine a failure in the indirect path in response to receiving the information associated with the second relay node or the failure information. In some embodiments of the present disclosure, the failure information may include the information associated with the second relay node. In some embodiments of the present disclosure, the BS may indicate to the UE to switch from the first relay node to the second relay node.

It should be appreciated by persons skilled in the art that the sequence of the operations in exemplary method 1300 may be changed and some of the operations in exemplary method 1300 may be eliminated or modified, without departing from the spirit and scope of the disclosure.

FIG. 14 illustrates an example of a UE 1400 in accordance with aspects of the present disclosure. The UE 1400 may include a processor 1402, a memory 1404, a controller 1406, and a transceiver 1408. The processor 1402, the memory 1404, the controller 1406, or the transceiver 1408, or various combinations thereof or various components thereof may be examples of means for performing various aspects of the present disclosure as described herein. These components may be coupled (e.g., operatively, communicatively, functionally, electronically, electrically) via one or more interfaces.

The processor 1402, the memory 1404, the controller 1406, or the transceiver 1408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1402 may include an intelligent hardware device (e.g., a general-purpose processor, a DSP, a CPU, an ASIC, an FPGA, or any combination thereof). In some implementations, the processor 1402 may be configured to operate the memory 1404. In some other implementations, the memory 1404 may be integrated into the processor 1402. The processor 1402 may be configured to execute computer-readable instructions stored in the memory 1404 to cause the UE 1400 to perform various functions of the present disclosure.

The memory 1404 may include volatile or non-volatile memory. The memory 1404 may store computer-readable, computer-executable code including instructions when executed by the processor 1402 cause the UE 1400 to perform various functions described herein. The code may be stored in a non-transitory computer-readable medium such as the memory 1404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1402 and the memory 1404 coupled with the processor 1402 may be configured to cause the UE 1400 to perform one or more of the functions described herein (e.g., executing, by the processor 1402, instructions stored in the memory 1404). For example, the processor 1402 may support wireless communication at the UE 1400 in accordance with examples as disclosed herein.

For example, the UE 1400 may be configured to support means for performing the operations as described with respect to FIG. 9. For example, the UE 1400 may be configured to support: a means for connecting to a BS (e.g., an NE) via multiple paths comprising an indirect path through a relay node and a direct path; and a means for receiving a notification message or a PC5-S release message from the relay node, wherein the notification message or PC5-S release message is transmitted by the relay node due to a Uu link failure, a handover, a cell reselection, a connection establishment failure of the relay node.

For example, the UE 1400 may be configured to support means for performing the operations as described with respect to FIG. 10. For example, the UE 1400 may be configured to support: a means for connecting to a BS (e.g., an NE) via multiple paths comprising a first indirect path and a direct path; a means for receiving, from the BS, a reconfiguration message instructing the UE to switch from the first indirect path to a second indirect path, wherein the reconfiguration message may indicate a target relay node; and a means for starting a timer for indirect path switch and perform an indirect path switch procedure towards the target relay node in response to receiving the reconfiguration message.

For example, the UE 1400 may be configured to support means for performing the operations as described with respect to FIG. 11. For example, the UE 1400 may be configured to support: a means for connecting to a BS (e.g., an NE) via a direct path; and a means for transmitting, to the BS, information associated with one or more candidate relay nodes, wherein the information associated with the one or more candidate relay nodes may indicate an ID of a first relay node and an ID of a cell serving the first relay node, the first relay node is in an idle mode or an inactive mode with the BS.

For example, the UE 1400 may be configured to support means for performing the operations as described with respect to FIG. 12. For example, the UE 1400 may be configured to support: a means for camping on a BS (e.g., an NE), wherein the UE is in an idle mode or an inactive mode with the BS; a means for transmitting, to another UE, an ID of the UE and an ID of a cell serving the UE, wherein the another UE connects to the BS via a direct path; and a means for transmitting, to the BS, the ID of the UE.

The controller 1406 may manage input and output signals for the UE 1400. The controller 1406 may also manage peripherals not integrated into the UE 1400. In some implementations, the controller 1406 may utilize an operating system such as iOS®, ANDROID®, WINDOWS®, or other operating systems. In some implementations, the controller 1406 may be implemented as part of the processor 1402.

In some implementations, the UE 1400 may include at least one transceiver 1408. In some other implementations, the UE 1400 may have more than one transceiver 1408. The transceiver 1408 may represent a wireless transceiver. The transceiver 1408 may include one or more receiver chains 1410, one or more transmitter chains 1412, or a combination thereof.

A receiver chain 1410 may be configured to receive signals (e.g., control information, data, or packets) over a wireless medium. For example, the receiver chain 1410 may include one or more antennas for receive the signal over the air or wireless medium. The receiver chain 1410 may include at least one amplifier (e.g., a low-noise amplifier (LNA)) configured to amplify the received signal. The receiver chain 1410 may include at least one demodulator configured to demodulate the receive signal and obtain the transmitted data by reversing the modulation technique applied during transmission of the signal. The receiver chain 1410 may include at least one decoder for decoding the processing the demodulated signal to receive the transmitted data.

A transmitter chain 1412 may be configured to generate and transmit signals (e.g., control information, data, or packets). The transmitter chain 1412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1412 may also include at least one power amplifier configured to amplify the modulated signal to an appropriate power level suitable for transmission over the wireless medium. The transmitter chain 1412 may also include one or more antennas for transmitting the amplified signal into the air or wireless medium.

It should be appreciated by persons skilled in the art that the components in exemplary UE 1400 may be changed, for example, some of the components in exemplary UE 1400 may be omitted or modified or a new component(s) may be added to exemplary UE 1400, without departing from the spirit and scope of the disclosure. For example, in some embodiments, the UE 1400 may not include the controller 1406.

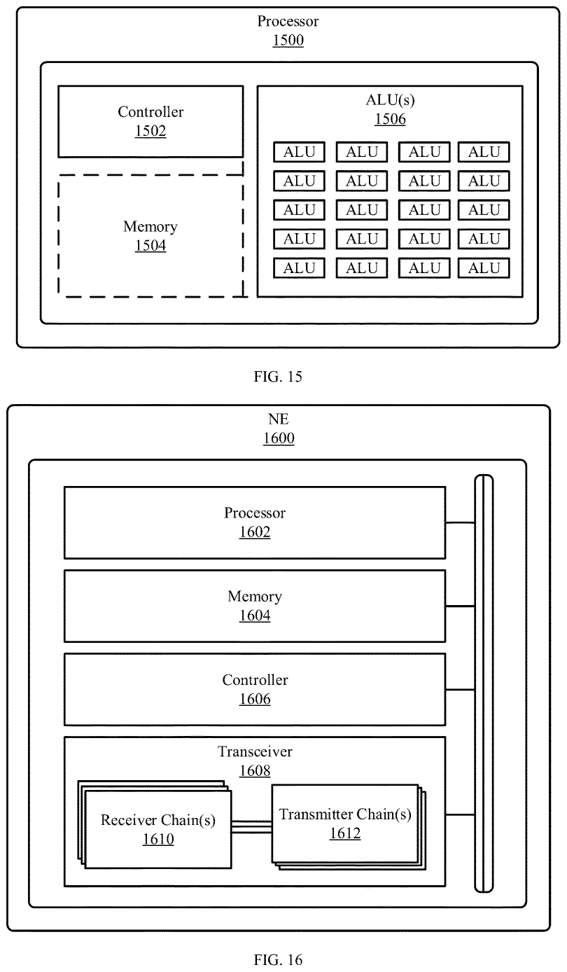

FIG. 15 illustrates an example of a processor 1500 in accordance with aspects of the present disclosure. The processor 1500 may be an example of a processor configured to perform various operations in accordance with examples as described herein. The processor 1500 may include a controller 1502 configured to perform various operations in accordance with examples as described herein. The processor 1500 may optionally include at least one memory 1504, which may be, for example, an L1/L2/L3 cache. Additionally, or alternatively, the processor 1500 may optionally include one or more arithmetic-logic units (ALUs) 1506. One or more of these components may be in electronic communication or otherwise coupled (e.g., operatively, communicatively, functionally, electronically, electrically) via one or more interfaces (e.g., buses).

The processor 1500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1502 may be configured to manage and coordinate various operations (e.g., signaling, receiving, obtaining, retrieving, transmitting, outputting, forwarding, storing, determining, identifying, accessing, writing, reading) of the processor 1500 to cause the processor 1500 to support various operations in accordance with examples as described herein. For example, the controller 1502 may operate as a control unit of the processor 1500, generating control signals that manage the operation of various components of the processor 1500. These control signals include enabling or disabling functional units, selecting data paths, initiating memory access, and coordinating timing of operations.

The controller 1502 may be configured to fetch (e.g., obtain, retrieve, receive) instructions from the memory 1504 and determine a subsequent instruction(s) to be executed to cause the processor 1500 to support various operations in accordance with examples as described herein. The controller 1502 may be configured to track memory address of instructions associated with the memory 1504. The controller 1502 may be configured to decode instructions to determine the operation to be performed and the operands involved. For example, the controller 1502 may be configured to interpret the instruction and determine control signals to be output to other components of the processor 1500 to cause the processor 1500 to support various operations in accordance with examples as described herein. Additionally, or alternatively, the controller 1502 may be configured to manage flow of data within the processor 1500. The controller 1502 may be configured to control transfer of data between registers, ALUs, and other functional units of the processor 1500.

The memory 1504 may include one or more caches (e.g., memory local to or included in the processor 1500 or other memory, such RAM, ROM, DRAM, SDRAM, SRAM, MRAM, flash memory, etc. In some implementations, the memory 1504 may reside within or on a processor chipset (e.g., local to the processor 1500). In some other implementations, the memory 1504 may reside external to the processor chipset (e.g., remote to the processor 1500).

The memory 1504 may store computer-readable, computer-executable code including instructions that, when executed by the processor 1500, cause the processor 1500 to perform various functions described herein. The code may be stored in a non-transitory computer-readable medium such as system memory or another type of memory. The controller 1502 and/or the processor 1500 may be configured to execute computer-readable instructions stored in the memory 1504 to cause the processor 1500 to perform various functions. For example, the processor 1500 and/or the controller 1502 may be coupled with or to the memory 1504, the processor 1500, the controller 1502, and the memory 1504 may be configured to perform various functions described herein. In some examples, the processor 1500 may include multiple processors and the memory 1504 may include multiple memories. One or more of the multiple processors may be coupled with one or more of the multiple memories, which may, individually or collectively, be configured to perform various functions herein.

The one or more ALUs 1506 may be configured to support various operations in accordance with examples as described herein. In some implementations, the one or more ALUs 1506 may reside within or on a processor chipset (e.g., the processor 1500). In some other implementations, the one or more ALUs 1506 may reside external to the processor chipset (e.g., the processor 1500). One or more ALUs 1506 may perform one or more computations such as addition, subtraction, multiplication, and division on data. For example, one or more ALUs 1506 may receive input operands and an operation code, which determines an operation to be executed. One or more ALUs 1506 be configured with a variety of logical and arithmetic circuits, including adders, subtractors, shifters, and logic gates, to process and manipulate the data according to the operation. Additionally, or alternatively, the one or more ALUs 1506 may support logical operations such as AND, OR, exclusive-OR (XOR), not-OR (NOR), and not-AND (NAND), enabling the one or more ALUs 1506 to handle conditional operations, comparisons, and bitwise operations.

The processor 1500 may support wireless communication in accordance with examples as disclosed herein.

For example, the processor 1500 may be configured to support means for performing the operations as described with respect to FIG. 9. For example, the processor 1500 may be configured to or operable to support: a means for connecting to a BS (e.g., an NE) via multiple paths comprising an indirect path through a relay node and a direct path; and a means for receiving a notification message or a PC5-S release message from the relay node, wherein the notification message or PC5-S release message is transmitted by the relay node due to a Uu link failure, a handover, a cell reselection, a connection establishment failure of the relay node.

For example, the processor 1500 may be configured to support means for performing the operations as described with respect to FIG. 10. For example, the processor 1500 may be configured to support: a means for connecting to a BS (e.g., an NE) via multiple paths comprising a first indirect path and a direct path; a means for receiving, from the BS, a reconfiguration message instructing a UE (e.g., the processor) to switch from the first indirect path to a second indirect path, wherein the reconfiguration message may indicate a target relay node; and a means for starting a timer for indirect path switch and perform an indirect path switch procedure towards the target relay node in response to receiving the reconfiguration message.

For example, the processor 1500 may be configured to support means for performing the operations as described with respect to FIG. 11. For example, the processor 1500 may be configured to support: a means for connecting to a BS (e.g., an NE) via a direct path; and a means for transmitting, to the BS, information associated with one or more candidate relay nodes, wherein the information associated with the one or more candidate relay nodes may indicate an ID of a first relay node and an ID of a cell serving the first relay node, the first relay node is in an idle mode or an inactive mode with the BS.

For example, the processor 1500 may be configured to support means for performing the operations as described with respect to FIG. 12. For example, the processor 1500 may be configured to support: a means for camping on a BS (e.g., an NE), wherein the processor is in an idle mode or an inactive mode with the BS; a means for transmitting, to another UE, an ID of the processor and an ID of a cell serving the processor, wherein the another UE connects to the BS via a direct path; and a means for transmitting, to the BS, the ID of the processor.

For example, the processor 1500 may be configured to support means for performing the operations as described with respect to FIG. 13. For example, the processor 1500 may be configured to support: a means for receiving, from a UE, information associated with one or more candidate relay nodes, wherein the UE connects to the processor via a direct path, the information associated with the one or more candidate relay nodes may indicate an ID of a first relay node and an ID of a cell serving the first relay node, the first relay node is in an idle mode or an inactive mode with the processor; and a means for transmitting, to the UE, a multipath configuration, wherein the multipath may include the direct path and an indirect path to the processor via the first relay node.

It should be appreciated by persons skilled in the art that the components in exemplary processor 1500 may be changed, for example, some of the components in exemplary processor 1500 may be omitted or modified or a new component(s) may be added to exemplary processor 1500, without departing from the spirit and scope of the disclosure. For example, in some embodiments, the processor 1500 may not include the ALUs 1506.

FIG. 16 illustrates an example of an NE 1600 in accordance with aspects of the present disclosure. The NE 1600 may include a processor 1602, a memory 1604, a controller 1606, and a transceiver 1608. The processor 1602, the memory 1604, the controller 1606, or the transceiver 1608, or various combinations thereof or various components thereof may be examples of means for performing various aspects of the present disclosure as described herein. These components may be coupled (e.g., operatively, communicatively, functionally, electronically, electrically) via one or more interfaces.

The processor 1602, the memory 1604, the controller 1606, or the transceiver 1608, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 1602 may include an intelligent hardware device (e.g., a general-purpose processor, a DSP, a CPU, an ASIC, an FPGA, or any combination thereof). In some implementations, the processor 1602 may be configured to operate the memory 1604. In some other implementations, the memory 1604 may be integrated into the processor 1602. The processor 1602 may be configured to execute computer-readable instructions stored in the memory 1604 to cause the NE 1600 to perform various functions of the present disclosure.

The memory 1604 may include volatile or non-volatile memory. The memory 1604 may store computer-readable, computer-executable code including instructions when executed by the processor 1602 cause the NE 1600 to perform various functions described herein. The code may be stored in a non-transitory computer-readable medium such as the memory 1604 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1602 and the memory 1604 coupled with the processor 1602 may be configured to cause the NE 1600 to perform one or more of the functions described herein (e.g., executing, by the processor 1602, instructions stored in the memory 1604). For example, the processor 1602 may support wireless communication at the NE 1600 in accordance with examples as disclosed herein.

For example, the NE 1600 may be configured to support means for performing the operations as described with respect to FIG. 13. For example, the NE 1600 may be configured to support: a means for receiving, from a UE, information associated with one or more candidate relay nodes, wherein the UE connects to the NE via a direct path, the information associated with the one or more candidate relay nodes may indicate an ID of a first relay node and an ID of a cell serving the first relay node, the first relay node is in an idle mode or an inactive mode with the NE; and a means for transmitting, to the UE, a multipath configuration, wherein the multipath may include the direct path and an indirect path to the NE via the first relay node.

The controller 1606 may manage input and output signals for the NE 1600. The controller 1606 may also manage peripherals not integrated into the NE 1600. In some implementations, the controller 1606 may utilize an operating system such as iOS®, ANDROID®, WINDOWS®, or other operating systems. In some implementations, the controller 1606 may be implemented as part of the processor 1602.

In some implementations, the NE 1600 may include at least one transceiver 1608. In some other implementations, the NE 1600 may have more than one transceiver 1608. The transceiver 1608 may represent a wireless transceiver. The transceiver 1608 may include one or more receiver chains 1610, one or more transmitter chains 1612, or a combination thereof.

A receiver chain 1610 may be configured to receive signals (e.g., control information, data, or packets) over a wireless medium. For example, the receiver chain 1610 may include one or more antennas for receive the signal over the air or wireless medium. The receiver chain 1610 may include at least one amplifier (e.g., an LNA) configured to amplify the received signal. The receiver chain 1610 may include at least one demodulator configured to demodulate the receive signal and obtain the transmitted data by reversing the modulation technique applied during transmission of the signal. The receiver chain 1610 may include at least one decoder for decoding the processing the demodulated signal to receive the transmitted data.

A transmitter chain 1612 may be configured to generate and transmit signals (e.g., control information, data, or packets). The transmitter chain 1612 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 1612 may also include at least one power amplifier configured to amplify the modulated signal to an appropriate power level suitable for transmission over the wireless medium. The transmitter chain 1612 may also include one or more antennas for transmitting the amplified signal into the air or wireless medium.

It should be appreciated by persons skilled in the art that the components in exemplary NE 1600 may be changed, for example, some of the components in exemplary NE 1600 may be omitted or modified or a new component(s) may be added to exemplary NE 1600, without departing from the spirit and scope of the disclosure. For example, in some embodiments, the NE 1600 may not include the controller 1606.

Those having ordinary skill in the art would understand that the operations or steps of the methods described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of the methods may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. The disclosure is not limited to the examples and designs described herein but is to be accorded with the broadest scope consistent with the principles and novel features disclosed herein. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, this document, the terms “handover” and “path switch” may be used interchangeably. The terms “path switch” and “path change” may be used interchangeably. The terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” or the like, as used herein, is defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE), comprising:
at least one memory; and
at least one processor coupled with the at least one memory and configured to cause the UE to:
connect to a base station (BS) via multiple paths comprising an indirect path through a relay node and a direct path; and
receive a notification message or a PC5-S release message from the relay node, wherein the notification message or PC5-S release message is transmitted by the relay node due to a Uu link failure, a handover, a cell reselection, a connection establishment failure of the relay node.

2. The UE of claim 1, wherein the at least one processor is configured to cause the UE to:
indicate, from a PC5-S layer of the UE to an access stratum (AS) layer of the UE, a release of a PC5 unicast link between the UE and the relay node in response to receiving the PC5-S release message.

3. The UE of claim 1, wherein the at least one processor is configured to cause the UE to:
in response to the direct path being not suspended, report failure information associated with the indirect path via the direct path; or
in response to the direct path being suspended, perform a reestablishment procedure.

4. The UE of claim 3, wherein the failure information indicates a reception of the notification message or the PC5-S release message.

5. A user equipment (UE), comprising:
at least one memory; and
at least one processor coupled with the at least one memory and configured to cause the UE to:
connect to a base station (BS) via multiple paths comprising a first indirect path and a direct path;
receive, from the BS, a reconfiguration message instructing the UE to switch from the first indirect path to a second indirect path, wherein the reconfiguration message indicates a target relay node; and
in response to receiving the reconfiguration message, start a timer for indirect path switch and perform an indirect path switch procedure towards the target relay node.

6. The UE of claim 5, wherein the at least one processor is configured to cause the UE to:
during the indirect path switch procedure, receive a notification message or a PC5-S release message from the target relay node or detect a sidelink radio link failure (RLF) between the UE and the target relay node.

7. The UE of claim 6, wherein the at least one processor is configured to cause the UE to:
in response to receiving the notification message or the PC5-S release message or detecting the sidelink RLF, stop the timer for indirect path switch or determine that the timer for indirect path switch is expired.

8. The UE of claim 6, wherein the at least one processor is configured to cause the UE to transmit, to the BS, failure information associated with indirect path switch via the direct path in response to receiving the notification message or the PC5-S release message or detecting the sidelink RLF.

9. The UE of claim 5, wherein the at least one processor is configured to cause the UE to:
transmit a sidelink reconfiguration message to the target relay node;
receive a sidelink reconfiguration failure message from the target relay node in response to transmitting the sidelink reconfiguration message; and
stop the timer for indirect path switch in response to receiving the sidelink reconfiguration failure message.

10. The UE of claim 5, wherein the at least one processor is configured to cause the UE to:
start a timer for sidelink reconfiguration in response to performing the indirect path switch procedure; and
stop the timer for indirect path switch in response to expiry of the timer for sidelink reconfiguration.

11. The UE of claim 9, wherein the at least one processor is configured to cause the UE to transmit, to the BS, failure information associated with the indirect path switch via the direct path in response to receiving the sidelink reconfiguration failure message or expiry of the timer for sidelink reconfiguration.

12. A user equipment (UE), comprising:
at least one memory; and
at least one processor coupled with the at least one memory and configured to cause the UE to:
connect to a base station (BS) via a direct path; and
transmit, to the BS, information associated with one or more candidate relay nodes, wherein the information associated with the one or more candidate relay nodes indicates an ID of a first relay node and an ID of a cell serving the first relay node.

13. The UE of claim 12, wherein the UE and the first relay node connect to each other using a non-3rd generation partnership project (3GPP) access technology.

14. (canceled)

15. (canceled)

16. The UE of claim 12, wherein the at least one processor is configured to cause the UE to:
establish an indirect path to the BS via the first relay node;
detect a failure in the indirect path or receive a notification message or a release message from the first relay node; and
transmit information associated with a second relay node to the BS in response to detecting the failure in the indirect path or receiving the notification message or the release message.

17. The UE of claim 12, wherein the at least one processor is configured to cause the UE to:
establish an indirect path to the BS via the first relay node;
detect a failure in the indirect path or receive a notification message or a release message from the first relay node; and
transmit failure information associated with the indirect path to the BS in response to detecting the failure in the indirect path or receiving the notification message or the release message.

18. The UE of claim 17, wherein the failure information comprises the information associated with a second relay node, wherein the UE and the second relay node connect to each other via a non-3rd generation partnership project (3GPP) link.

19. The UE of claim 12, wherein the at least one processor is configured to cause the UE to:
establish an indirect path to the BS via the first relay node; and
transmit, to the BS, information associated with a second relay node and an indicator indicating whether to switch from the first relay node to the second relay node in response to the indirect path being established, wherein the UE and the second relay node connect to each other via a non-3rd generation partnership project (3GPP) link.

20. A relay node, comprising:
at least one memory; and
at least one processor coupled with the at least one memory and configured to cause the relay node to:
camp on a base station (BS);
transmit, to a user equipment (UE), an ID of the relay node and an ID of a cell serving the relay node, wherein the UE connects to the BS via a direct path; and
transmit, to the BS, the ID of the relay node.

21. A base station (BS), comprising:
at least one memory; and
at least one processor coupled with the at least one memory and configured to cause the BS to:
receive, from a user equipment (UE), information associated with one or more candidate relay nodes, wherein the UE connects to the BS via a direct path, the information associated with the one or more candidate relay nodes indicates an ID of a first relay node and an ID of a cell serving the first relay node; and
transmit, to the UE, a multipath configuration, wherein the multipath comprises the direct path and an indirect path to the BS via the first relay node.

22. The BS of claim 21, wherein the at least one processor is further configured to cause the BS to:
establish the indirect path with the UE in response to transmitting the multipath configuration;
receive, from the UE, information associated with a second relay node or failure information associated with the indirect path; and
determine a failure in the indirect path in response to receiving the information associated with the second relay node or the failure information.
